(19) United States
(12) Patent Application Publication
(10) Pub. No.: US 2006/0225785 A1
(43) Pub. Date: Oct. 12, 2006

(54) Sealing structure of float valve

(75) Inventor: Hiroshi Oosaki, Koga City (JP)

Correspondence Address: OLIFF & BERRIDGE, PLC, P.O. BOX 19928, ALEXANDRIA, VA, 22320, US

(73) Assignee: KYOSAN DENKI CO., LTD., KOGA CITY (JP)

(21) Appl. No.: 11/386,664

(22) Filed: Mar. 23, 2006

(30) Foreign Application Priority Data
Apr. 8, 2005 (JP) 2005-111506

(51) Int. Cl. F16K 24/04

(52) U.S. Cl. 137/202

(57) ABSTRACT

A sealing structure includes a case; an upper opening; a first valve element; and a second valve element. The float moves upward and downward in the case. The opening is formed in the top surface of the case. The first valve element is provided in the upper area of the float. The first valve element opens and closes the opening. The second valve element is elastic, and is provided below the first valve element in the upper area of the float. The second valve element opens and closes the opening. At least one of the first valve element and the second valve element opens and closes the opening.

### INCORPORATION BY REFERENCE

The disclosure of Japanese Patent Application No. 2005-111506 filed on Apr. 8, 2005 including the specification, drawings and abstract is incorporated herein by reference in its entirety.

### BACKGROUND OF THE INVENTION

1. Field of the Invention

The invention relates to the sealing structure of a float valve. More specifically, the invention relates to the sealing structure of a float valve that allows fuel evaporative gas to flow from a fuel tank to a canister so that an adsorbent in the canister adsorbs the fuel evaporative gas, and that prevents fuel in the fuel tank from flowing to the canister when a fuel level goes up, for example, in vehicles.

2. Description of the Related Art

FIG. 6 shows the conventional sealing structure of a float valve provided in the fuel system of vehicles. The sealing structure of a float valve 1 includes a resin case 2; a resin float 5 that is provided in a space in the case 2; and a valve element 4 that is integrally formed in the upper area of the resin float 5. The case 2 is inserted in a fuel tank 6. A cover 3 is provided above the case 2. The cover 3 is fitted to the top surface of the fuel tank 6.

An opening 9 is formed in substantially the center of the top surface of the case 2. A valve seat 8 is formed around the opening 9. A plurality of vent holes 7 are formed in the upper area of the side surface of the case 2. Fuel evaporative gas passes through the vent holes 7. A plurality of fuel holes 10 are formed in the bottom surface of the case 2. Fuel passes through the plurality of fuel holes 10.

Ordinarily, the float 5 is located in the lower position and the opening 9 is open. Therefore, if fuel evaporative gas is generated in the fuel tank 6 due to an increase in the temperature inside the fuel tank 6 or any other reason, the fuel evaporative gas flows into the case 2 through the vent holes 7 and the fuel holes 10. Then, the fuel evaporative gas flows to a canister (not shown) through the opening 9 and a communication passage 11 that opens into the cover 3. An adsorbent in the canister adsorbs the fuel evaporative gas. In the float valve, the valve element 4 is formed integrally with the resin float 5, and the valve seat 8 is formed integrally with the resin case 2. Therefore, the opening 9 is sealed by making the resin valve element 4 contact the resin valve seat 8.

A fuel level 12 in the fuel tank 6 greatly changes, for example, when a vehicle moves upward and downward, or a vehicle turns. Then, part of fuel flows into the case 2 through the fuel holes 10, and the fuel pushes the float 5 upward. Then, the valve element 4 formed in the upper area of the float 5 contacts the valve seat 8 formed around the opening 9, thereby closing the opening 9. This prevents fuel from flowing to the canister through the opening 9 and the communication passage 11 (refer to Japanese Patent Application Publication No. JP-A-8-244477).

In the float valve, the opening 9 is sealed by making the resin valve element 4 and the resin valve seat 8 contact each other. However, accuracy in making the surfaces of the resin valve element 4 and the resin valve seat 8 contact each other needs to be increased to improve the effect of sealing the opening 9. The accuracy may be lower than required when the resin valve element 4 and the resin valve seat 8 formed by resin molding are used. In such a case, surface treatment needs to be performed on the valve element 4 and the valve seat 8 after they are formed. However, such surface treatment increases the cost of the valve element 4 and the valve seat 8.

The fuel tank in a vehicle or the like constantly receives vibrations. Therefore, when the fuel tank receives strong vibrations, the valve element 4 is separated from the valve seat 8, and fuel in the case 2 flows out through the opening 9 even if surface treatment is performed on the resin valve element 4 and the resin valve seat 8.

### SUMMARY OF THE INVENTION

An object of the invention is to provide the sealing structure of a float valve where an opening is double-sealed using a valve element made of resin or the like and an elastic valve element so that the effect of sealing the opening is improved.

A first aspect of the invention relates to the sealing structure of a float valve. The sealing structure includes a case; a float; an opening; a first valve element; and a second valve element. The float moves upward and downward in the case. The opening is formed in the top surface of the case. The first valve element is provided in the upper area of the float. The first valve element opens and closes the opening. The second valve element is elastic, and is provided below the first valve element in the upper area of the float. The second valve element opens and closes the opening. At least one of the first valve element and the second valve element opens and closes the opening.

With this configuration, the accuracy in closing the opening using the first valve element does not need to be extremely high. Even if the first valve element temporarily opens the opening when a vehicle moves up and down, or when the vehicle turns, the second valve element keeps closing the opening to prevent fuel from flowing out through the opening.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 illustrates a cross sectional view showing an entire float valve where an opening is closed by a valve element according to an embodiment;

FIG. 2 illustrates an enlarged cross sectional view showing the valve element that closes the opening according to the embodiment;

FIG. 3 illustrates an enlarged cross sectional view showing the valve element that opens the opening according to the embodiment;

FIG. 4 illustrates an enlarged cross sectional view showing a valve element according to a modified example of the embodiment;

FIG. 5 illustrates a cross sectional view showing a valve element according to another modified example of the embodiment; and

FIG. 6 illustrates a cross sectional view showing an entire float valve in related art.

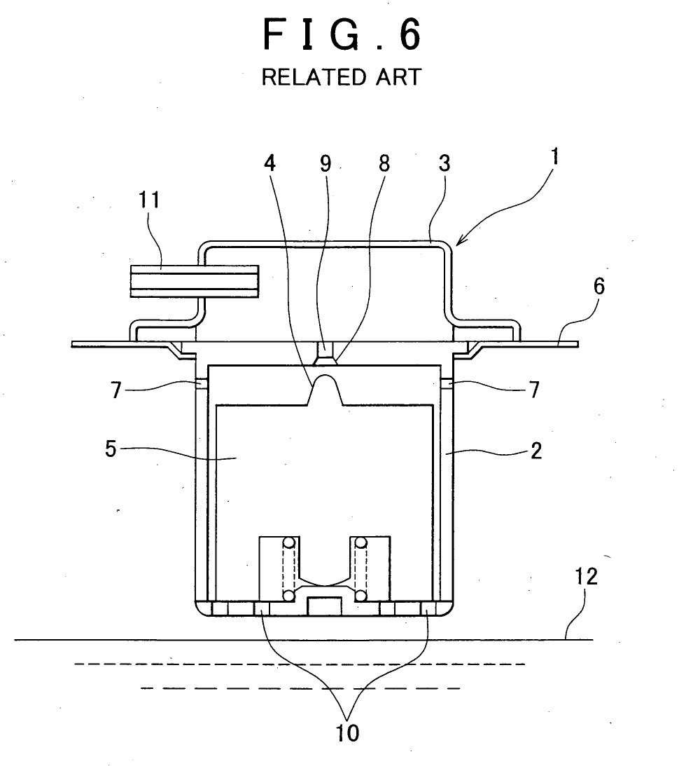

### DETAILED DESCRIPTION OF THE EXAMPLE EMBODIMENTS

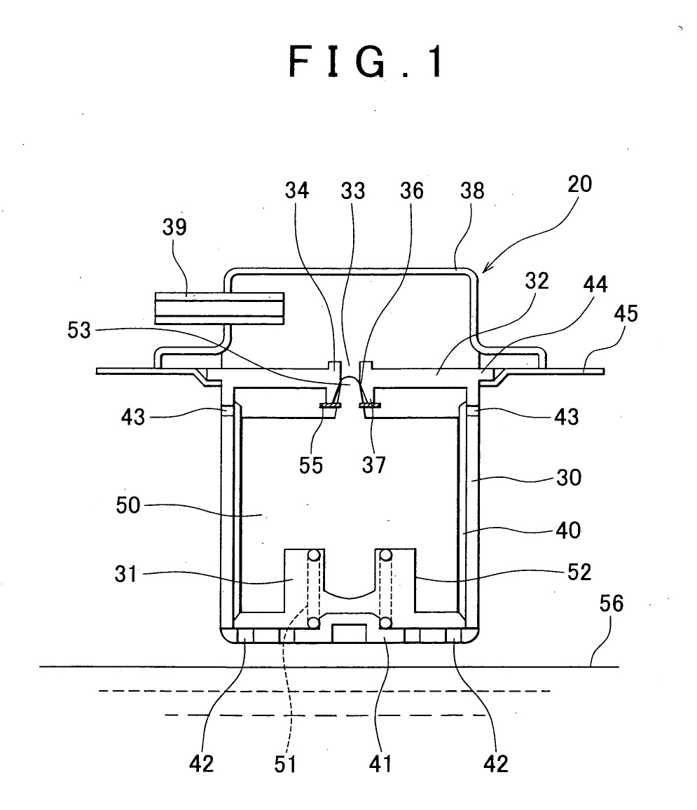

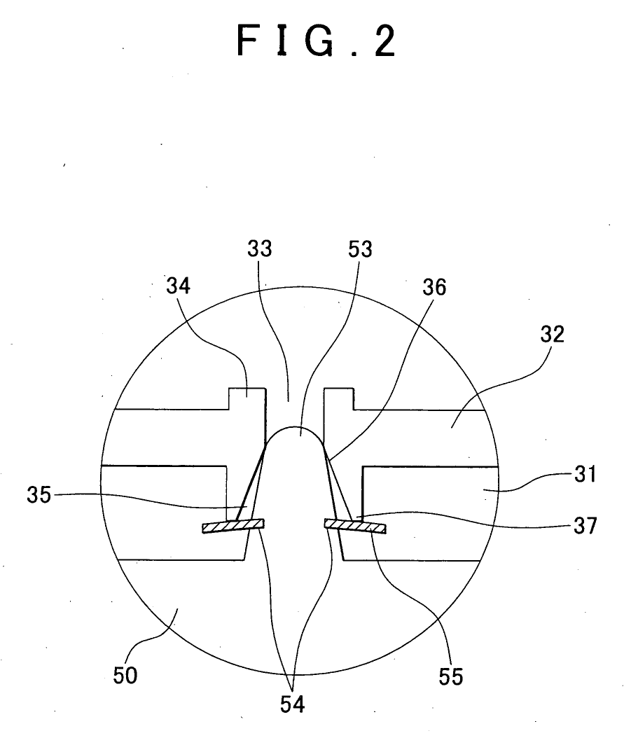

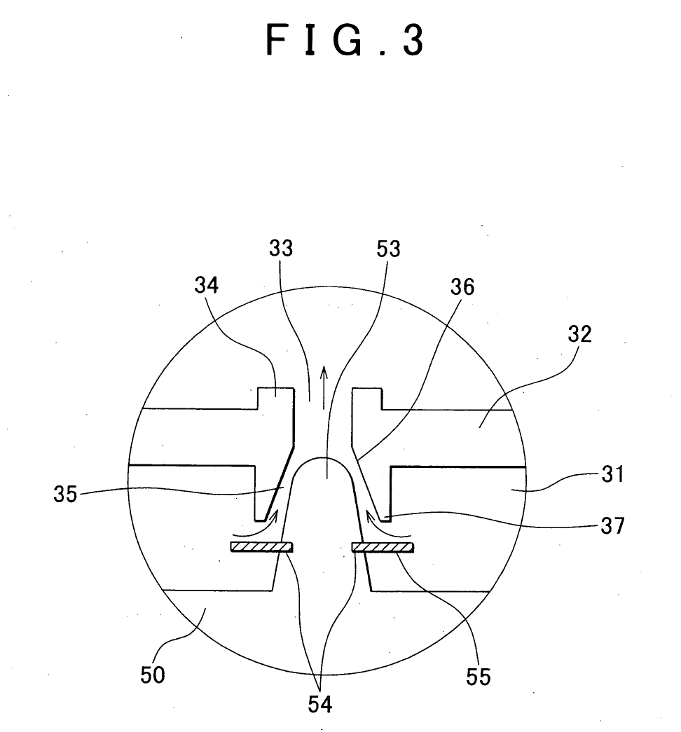

FIG. 1 illustrates the cross sectional view showing an entire float valve where an opening is closed by a valve element. FIG. 2 illustrates an enlarged cross sectional view showing the valve element in FIG. 1. FIG. 3 illustrates an enlarged cross sectional view showing the valve element that opens the opening. The sealing structure of the float valve according to the embodiment may be used for any purposes. However, the case where the sealing structure of the float valve is used in the fuel system of a vehicle will be described.

A float valve 20 includes a case 30; a float 5; and a flange 44. The float 50 is provided in the case 30. The flange 44 is used to fix the case 30 to a fuel tank 45.

The case 30 is made of resin. The bottom of the case 30 is open. A space 31 is formed inside the case 30. A cylindrical body 34 is integrally formed in the center of a top surface 32. An upper opening 33 is formed in the center of the cylindrical body 34. Communication is provided between the space 31 and the opening 33. A taper passage 35 is formed inside the cylindrical body 34. The substantially lower half of the taper passage 35 expands downward. A first valve seat 36 is formed in the upper area of the taper passage 35. A first valve element 53 (described later) contacts the first valve seat 36. Further, a second valve seat 37 is formed on the bottom surface of the cylindrical body 34. A second valve element 55 (described later) contacts the second valve seat 37.

Also, a case cover 38 is provided above the upper opening 33. A communication passage 39 is connected to the case cover 38. The communication passage 39 is connected to a canister (not shown). Fuel evaporative gas in a fuel tank is discharged to the canister through the communication passage 39. Also, atmospheric air is introduced into the fuel tank through the communication passage 39.

A plurality of ribs 40 extend in the vertical direction along the inner surface of the case 30. The ribs 40 form spaces between the inner surface of the case 30 and the float 50. That is, the ribs 40 form passages through which fuel evaporative gas and the like flow. The protrusions of the ribs 40 guide the float 50 when the float 50 moves upward and downward.

A bottom plate 41 is fitted to the bottom of the case 30. A plurality of bottom openings 42 are formed in the bottom plate 41. Fuel and the like flow into the space 31 through the bottom openings 42. Fuel in the fuel tank 45 flows into the space 31 through the bottom openings 42, for example, when fuel is supplied.

A plurality of vent holes 43 are formed in the upper area of the side wall surface of the case 30. Fuel evaporative gas in the fuel tank 45 flows into the space 31 through the vent holes 43, and flows to the canister (not shown) through the communication passage 39. Further, a flange 44 is integrally formed in the upper end of the side surface of the case 30. The float valve 20 is inserted in the fuel tank 45. By fixing the flange 44 to the top surface of the fuel tank 45, the float valve 20 is fitted to the fuel tank 45.

The float 50 has a substantially columnar shape. The float 50 is formed using light resin. A recess 52 is formed in the bottom of the float 50. A coil spring 51 is provided in the recess 52. The spring 51 is provided between the recess 52 and the bottom plate 41. The spring 51 cannot move the float 50 upward by itself. However, when fuel flows into the case 30, the spring 51 assists the float 50 in moving upward.

The first valve element 53 is integrally formed in the upper area of the float 50. The first valve element 53 is a protrusion that expands downward. When the upper opening 33 is closed, the first valve element 53 contacts the first valve seat 36 formed in the upper area of the taper passage 35.

A groove 54 that has a ring shape is formed in the lower area of the first valve element 53 as shown in FIG. 2 and FIG. 3. A second valve element 55 is fitted into the groove 54. The second valve element 55 has a flat and ring shape. The second valve element 55 is made of rubber.

When the upper opening 33 is closed, the second valve element 55 contacts the second valve seat 37 formed on the bottom surface of the cylindrical body 34. As shown in FIG. 2, when the second valve element 55 contacts the second valve seat 37, the second valve seat 37 pushes the second valve element 55 downward such that the outer periphery of the second valve element 55 bends downward. That is, the second valve element 55 is deformed. The first valve element 53 contacts the first valve seat 36, and the second valve element 55 contacts the second valve seat 37 at substantially the same time. The force pressing the first valve element 53 to the first valve seat 36 is substantially equal to the force pressing the second valve element 55 to the second valve seat 37.

Even if the first valve element 53 is separated from the first valve seat 36 due to vibrations of the vehicle or any other reason, the second valve element 55 remains in contact with the second valve seat 37 as long as the second valve element 55 remains deformed. This prevents fuel in the space 31 from flowing through the upper opening 33.

Assembly of the float valve 20 will be described. First, the case 30 is turned upside down. The float 50 where the second valve element 55 is fitted in the groove 54 is inserted in the case 30 such that the first valve element 53 is fitted into the taper passage 35 of the cylindrical body 34. Next, an end of the coil spring 51 is inserted in the recess 52 at the bottom of the float 50.

Next, the bottom plate 41 is fixed to the bottom of the case 30 by adhesive agent, welding, snap-fitting, or the like, whereby the bottom of the case 30 is closed. At this step, the other end of the coil spring 51 contacts the top surface of the bottom plate 41. After the float valve 20 is assembled, the float valve 20, which is in the upright position, is inserted in the fuel tank 45. Then, the flange 44 is fixed on the top surface of the fuel tank 45.

At least one of the first valve element 53, the second valve element 55, the first valve seat 36, and the second valve seat 37 may be formed using oil-shedding material or water-shedding material. Alternatively, oil-shedding surface treatment or water-shedding surface treatment may be performed on at least one of the first valve element 53, the second valve element 55, the first valve seat 36, and the second valve seat 37.

There are multiple asperities on the surfaces of the first valve element 53, the second valve element 55, the first valve seat 36, and the second valve seat 37. Therefore, unexpected fuel leak may occur due to the asperities. However, by forming at least one of the first valve element 53, the second valve element 55, the first valve seat 36, and the second valve seat 37 using oil-shedding material or water-shedding material, or by performing oil-shedding surface treatment or water-shedding surface treatment on at least one of the first valve element 53, the second valve element 55, the first valve seat 36, and the second valve seat 37, such unexpected fuel leak can be reliably prevented.

Next, the effects of the float valve will be described. Ordinarily, a fuel surface 56 is at the position shown in FIG. 1. Fuel evaporative gas generated in the fuel tank 45 flows into the space 31 through the vent holes 43 and the bottom openings 42, and flows to the canister through the upper opening 33 and the communication passage 39. Even if the fuel surface 56 closes the bottom openings 42 due to vibrations of the fuel tank 45, the fuel evaporative gas is discharged through the vent holes 43 without any trouble because the vent holes 43 are formed in the upper area of the case 30.

Fuel flows into the space 31 through the bottom openings 42 due to great vibrations of the fuel surface 56, for example, when the vehicle moves up and down, or the vehicle turns. The fuel is about to flow into the communication passage 39 through the space 31 between the inner surface of the case 30 and the side surface of the float 50, and the upper openings 33.

However, the fuel that flows into the space 31 pushes the float 50 upward. Further, buoyant force and the force of the spring 51 are also applied to the float 50. Therefore, the float 50 moves upward immediately. As a result, the first valve element 53 contacts the first valve seat 36, and the second valve element 55 contacts the second valve seat 37.

As shown in FIG. 2, when the second valve element 55 contacts the second valve seat 37, the outer periphery of the second valve element 55 bends downward, that is, the second valve element 55 is deformed. As a result, the first valve element 53 contacts the first valve seat 36, and the second valve element 55 contacts the second valve seat 37 at substantially the same time. The force pressing the first valve element 53 to the first valve seat 36 is substantially equal to the force pressing the second valve element 55 to the second valve seat 37. Accordingly, the upper opening 33 is double-sealed.

Because both of the first valve element 53 and the first valve seat 36 are made of resin, the first valve element 53 may be separated from the first valve seat 36 due to strong vibrations of the fuel tank 45 or any other reason. However, even if the first valve element 53 is separated from the first valve seat 36, the second valve element 55 remains in contact with the second valve seat 37 as long as the second valve element 55 remains deformed. This prevents fuel in the space 31 from flowing through the upper opening 33. When the upper opening 33 is open, fuel evaporative gas flows through the upper opening 33 as shown by arrows in FIG. 3.

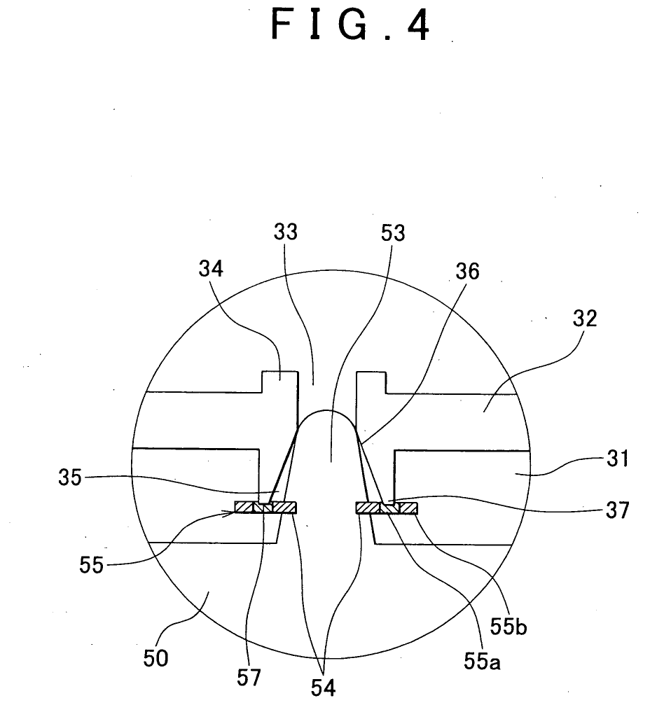

FIG. 4 shows the second valve element 55 in a modified example. The second valve element 55 in the modified example includes an elastic member 55a; and an elastic member 55b that has elastic force lower than that of the elastic member 55a. The elastic member 55a includes an area that contacts the second valve seat 37. The elastic member 55b is located inside and outside the elastic member 55a. The other configurations are the same as those shown in FIG. 1 to FIG. 3, and detailed description thereof will be omitted.

In the modified example, when the second valve element 55 contacts the second valve seat 37, the area of the elastic member 55a that contacts the second valve seat 37 is dented, and the entire second valve element 55 is kept in the horizontal position. A recess 57 is formed at the area of the elastic member 55a that contacts the second valve seat 37, as shown in FIG. 4.

In the modified example shown in FIG. 4, the second valve element 55 is in the horizontal position when the second valve element 55 contacts the second valve seat 37. In the cross sectional view, the three sides of the second valve element 55 contact the second valve seat 37. The elastic member 55b may be a solid member made of metal or the like.

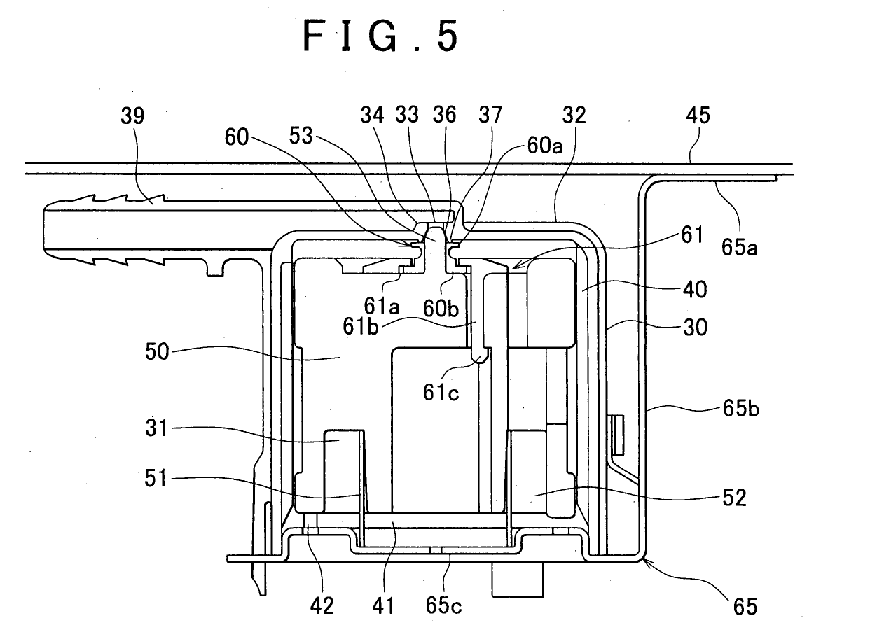

FIG. 5 shows another modified example of the embodiment. The second valve element shown in FIG. 2 has a ring shape. Therefore, the strength of the second valve element is slightly low. In contrast, in this modified example shown in FIG. 5, the strength of the second valve element is increased. The same and corresponding members as those in the embodiment shown in FIG. 1 are denoted by the same reference numerals, and detailed description thereof will be omitted.

A second valve element 60 is cylindrical. The second valve element 60 includes a valve element 60a located at an upper position; and a flange 60b located at a lower position. The valve element 60a has a ring shape, and protrudes in the radial direction, and contacts the second valve seat 37. The flange 60b has a ring shape, and protrudes in the radial direction. The second valve element 60 has a hollow in the center. The hollow has a circle cross section. A bar-shaped first valve element 53 is fitted in the hollow.

A valve-element support member 61 includes a ring stage 61a; and three engagement portions 61b. An opening is formed in the center of the ring stage 61a. Each engagement portion 61b extends downward from the ring stage 61a. An engagement claw is provided at the end of each engagement portion 61b.

The second valve element 60 is fitted to the float 50 in the manner described below. The second valve element 60 is fitted to the bar-shaped first valve element 53 from above. Then, the valve-element support member 61 is fitted to the second valve element 60 from above. As a result, the bottom surface of the ring step 61a of the valve-element support member 61 contacts the top surface of the flange 60b of the second valve element 60.

By further pushing the valve-element support member 61 downward, the engagement claws 61c provided at the ends of the respective three engagement portions 61b engage with the bottom of the recess 52 of the float 50. As a result, the valve-element support member 61 supports the second valve element 60, and the valve-element support member 61 engages with the float 50.

By employing the second valve element 60 having the aforementioned configuration, the strength of the second valve element 60 can be increased, and the second valve element 60 can contact the second valve seat 37 reliably. Also, by disengaging the engagement claws 61c from the recess 52 of the float 50, the second valve element 60 can be removed. Therefore, the second valve element 60 can be replaced with new one easily.

In the embodiment shown in FIG. 1, the opening is formed in the top surface of the fuel tank 45. The case 30 is fixed in the outer surface of the top of the fuel tank 45 such that the case 30 is suspended from the top of the fuel tank 45. In the modified example shown in FIG. 5, a support member 65 is fixed at the inner surface of the top of the fuel tank 45 such that the support member 65 is suspended from the top of the fuel tank 45, and the case 30 is supported by the support member 65.

In the modified example shown in FIG. 5, the support member 65 that supports the case 30 is provided. The support member 65 is fixed in the inner surface of the top of the fuel tank 45 such that the support member 65 is suspended from the top of the fuel tank 45, and the case 30 is supported by the support member 65. The support member 65 has a crank shape, and includes a horizontal top portion 65a; a vertical portion 65b; and a horizontal bottom portion 65c. As shown in FIG. 5, the horizontal top portion 65a is fitted to the inner surface of the top of the fuel tank 45, and the horizontal bottom portion 65c is fitted to the bottom of the case 30, whereby the case 30 is supported by the horizontal bottom portion 65c.

With this configuration, an opening does not need to be formed in the top surface of the fuel tank 45. This prevents leak of fuel and the like.

The invention is not limited to the aforementioned embodiments. The design may be appropriately changed without departing from the true spirit of the invention.

What is claimed is:

1. A sealing structure of a float valve, comprising:
a case;
a float that moves upward and downward in the case;
an opening formed in a top surface of the case;
a first valve element that is provided in an upper area of the float, and that opens and closes the opening; and
a second valve element that is elastic and is provided below the first valve element in the upper area of the float, and that opens and closes the opening, wherein at least one of the first valve element and the second valve element opens and closes the opening.

2. The sealing structure according to claim 1, wherein the second valve element is made of rubber.

3. The sealing structure according to claim 1, wherein a first valve seat that contacts the first valve element, and a second valve seat that contacts the second valve element are formed around the opening.

4. The sealing structure according to claim 1, wherein the second valve element is deformed by the second valve seat when the opening is closed.

5. The sealing structure according to claim 1, wherein the first valve element is a protrusion that expands downward, and the second valve element has a ring shape.

6. The sealing structure according to claim 3, wherein at least one of the first valve element, the second valve element, the first valve seat, and the second valve seat is made of oil-shedding material or water-shedding material.

7. The sealing structure according to claim 1, wherein the float valve is used in a fuel system of a vehicle.

8. The sealing structure according to claim 1, wherein:
the second valve element includes a hollow, a first flange provided at a lower end, and a second flange provided at an upper end, which opens and closes the opening; and
the first valve element is fitted in the hollow, and the second flange is fixed to the float using a fixing member.

9. The sealing structure according to claim 3, wherein:
the second valve element includes a first member and a second member;
the first member includes an area that contacts the second valve seat, and the second member is provided inside and outside the first member; and
elastic force of the first member is greater than that of the second member.

10. The sealing structure according to claim 1, wherein the float further includes a spring that pushes the float toward the opening.

11. The sealing structure according to claim 1, wherein the float moves upward, and at least one of the first valve element and the second valve element closes the opening when fluid flows into the case.
